(19) United States
(12) Patent Application Publication
(10) Pub. No.: US 2007/0190953 A1
(43) Pub. Date: Aug. 16, 2007

(54) Method of generating uwb pulses

(76) Inventors: Adrian Tan Eng Choon, Singapore (SG); Michael Chia Yan Wah, Singapore (SG)

Correspondence Address: DICKSTEIN SHAPIRO LLP, 1825 EYE STREET NW, Washington, DC, 20006-5403, US

(21) Appl. No.: 10/585,375

(22) PCT Filed: Jan. 6, 2004
(86) PCT No.: PCT/SG04/00006

§ 371 Date: Jul. 6, 2006

(51) Int. Cl. H01Q 11/12; H04B 1/04

(52) U.S. Cl. 455/127.1; 455/126

(57) ABSTRACT

A method produces UWB pulses (73, 75) using a differentiated clock signal as a pulse input (71, 72), and a data signal to modulate the pulse input. The mixed signal is then differentiated a second time to produce high frequency broad band UWB signals. A differentiating system which comprises a transistor, a lowpass filter at the output of the transistor, the output of the lowpass filter negatively fedback to the input of the transistor, whereby the output of system has a high voltage swing capable of being matched to an antenna without further need of amplification, and the system is capable of implementation on an IC.

### FIELD OF THE INVENTION

This invention relates to the field of Ultra Wideband (UWB) signals.

### BACKGROUND

UWB technology for wireless communication, unlike other wireless communication technology, uses short pulses (also known as wavelets in some publications) as information bearing signals and is virtually carrierless. In other words, the information to be transmitted resides in the pulses and is not modulated and riding on any carrier frequency. This technology is energy efficient and has very low average signal power spectral density, since the short pulses are interspersed with long ‘quiet’ intervals when transmitted.

UWB technology is not only applied to wireless communication systems. As stated in “UWB Report and Order news release”, 14 Feb. 2002, it has potential in imaging, ground penetrating radar, wall imaging, through-wall imaging, medical systems, surveillance, vehicular radar and measurement systems.

In an example of UWB data transmission, data is characterised by the positions or intervals between UWB pulses (i.e. pulse position modulation). The periods between the received pulses are used to reconstruct the data. In another method, the UWB pulses are such that they are shaped to represent data. In yet another method, different amplitudes of the pulses are used to represent binary information. Whichever method is used, the pulse generation step is crucial to the operation of any UWB systems.

The most basic UWB pulse is a monocycle. FIG. 1a and 1b respectively show a monocycle pulse with a 1-nanosecond width and its equivalent in the frequency domain. Other types of UWB pulses include step signals, Gaussian pulses, polycyclical signals and windowed sinusoids.

As the pulses are very short bursts of signals, an UWB system is inherently broadband. UWB can therefore interfere with, and be interfered by, existing communication systems. This was the cause of hesitation in governing authorities in permitting commercialisation and privatisation of UWB technology.

However, in February 2002, Federal Communications Commission (FCC) adopted the first Report and Order permitting the marketing and operation of UWB technology. One year later, on 13 Mar. 2003, FCC made amendments to Part 15 and subpart-F, wherein details on what constitute unlicensed Ultra Wide Band Transmission Systems is described. The FCC does not specify any requirement on UWB pulse generation and shape, but it specifies the allowed bandwidth for different UWB systems via various EIRP masks. EIRP refers to the highest signal strength detected in any direction and at any frequency from the UWB device, in accordance with the procedures specified in the document. The FCC defines a UWB transmitter as a radiator which, at any point in time, has a fractional bandwidth equal to or greater than 0.20 or has a UWB bandwidth equal to or greater than 500 MHz regardless of the fractional bandwidth.

The graphs in FIG. 1c to 1f show a pictorial summary of different FCC approved UWB systems. FIG. 1c shows the bandwidth for UWB used in Indoor Systems, FIG. 1d shows the bandwidth for UWB used in Outdoor-Handheld Systems, FIG. 1e shows the bandwidth for UWB used in GPR, Wall-Imaging and Medical-Imaging Systems, FIG. 1f shows the bandwidth for UWB used in ‘Through-Wall-Imaging’ and Surveillance Systems.

A UWB signal can generally be characterised by its peak amplitude, time decay constant and pulse width. The equation representing a basic UWB monocycle in time domain as shown in FIG. 1a is

$$y ( t ) = A \frac{\sqrt{2 ⅇ}}{τ} t {ⅇ}^{- {( \frac{t}{τ} )}^{2}}$$

where A is the peak amplitude and τ is time decay constant.

In frequency domain, the peak amplitude relates to average signal power, the time decay constant relates to the center frequency of the pulse and the pulse width relates to signal frequency spread. The equation representing a basic UWB monocycle in frequency domain as shown in FIG. 1b is

$$Y ( w ) = Aw {τ}^{2} \sqrt{2 π ⅇ} {ⅇ}^{- \frac{{w}^{2} {τ}^{2}}{2}}$$

where A is the peak amplitude and τ is time decay constant.

WO 02/31986, “System and Method for Generating Ultra Wideband Pulses” McCorkle, John, discloses one method of UWB signal generation. In that method, a semi-square wave clock signal is firstly split into two streams. One stream is then fed to a series of buffers, while the other stream fed to just one buffer. The two series of buffers cause a phase lag between the two streams (WO 02/31986 page 28 paragraph 1, FIG. 6). The streams are then fed into either an exclusive OR gate or AND gate to produce a combined single stream which has twice the frequency of the original clock output. This combined stream of signal is then fed into yet another two series of buffers which causes yet another two resultant square wave streams having a phase delay between them. The leading stream of pulses is then fed into a non-inverting differential LO input of a multiplier, while the lagging stream is fed into an inverting differential LO input of the same multiplier. A third input of differential data signal is also fed into the same multiplier. The result is a stream of monocycles from the combination of the non-inverted leading pulses, the inverted lagging pulses and the data signal. The resultant stream consists of UWB wavelets of ground-positive-negative-ground pulses represent ‘1’ and ground-negative-positive-ground pulses represent ‘0’ (WO 02/31986, page 25 line 24-25, FIG. 5a and FIG. 5b).

FIG. 2a and 2b of the present specification shows an illustration of McCorkle's method. Two streams of square waves are fed into a LO having an inverting and non-inverting input to produce A+ 21a, 21b, which is a train of subnanosecond positive pulses, and A− 22a, 22b, which is a train of subnanosecond negative pulses. A− is delayed with respect to A+ by exactly the time width of the A+ pulse. ΔB 23, 23b is a differential data signal and is modulated with signals A+ and A− in multiplier 25 to produce a differential, biphase, modulated monocycle, ΔC 24, 24b. McCorkle's method can also be used to generate UWB pulses of other shapes.

However, UWB signals generated by McCorkle's method have limited output power and low voltage swing, and are therefore difficult to match to an antenna, i.e. UWB signals so generated probably need to be passed through a wideband amplifier before they can be fed to a transmitting antenna.

FIG. 3 illustrates a method of UWB signal generation as described in U.S. Pat. No. 6,026,125 “Waveform Adaptive Ultra Wideband Transmitter” Larrick. An impulse generator 31 excites a pulse-shaping filter 32, the output of which is used to directly gate the output of an oscillator 33 by a switching mixer 34. This is done to alternately pass or not pass the oscillator signal to the input of a band pass filter 35. The resulting signal 36 is then fed into an amplifier/attenuator 37 before being output via an antenna 38. Larrick's method has a problem of signal leaking from LO into the output which corrupts the UWB output.

FIG. 4 illustrates a method of generating UWB signals described in Jeong Soo Lee, Cam Nguyen and Tom Scullion, “New Unipolar Subnanosecond Monocycle Pulse Generator and Transformer for Time Domain Microwave Application.” IEEE Trans. on M.T.T. Vol. 49, No. 6, June 2001, pg. 1126 and Jeongwoo Han and Cam Nguyen, “A New Ultra Wideband, Ultra Short Monocycle Pulse Generator with Reduced Ringing.” IEEE Trans. on M.T.T. Vol. 12, No. 6, June 2002, pg. 206. In this method, a trigger signal 41 drives a Step recovery diode 42 (SRD) to output a sharp signal edge. This signal edge is passed through a shorted stub transmission line 43. Due to signal reflection from the short circuit at the stub end 43, a delayed edge with opposite polarity is combined with the original signal edge to form a Gaussian-like pulse. The pulse signal goes through an isolator circuit 44, and then to another shorted stub transmission line 45, which converts the pulse into a monocycle. This monocycle is fed into an antenna 46 (represented by a load resistance). This method of UWB signal generation is capable of generating sufficiently high-powered monocycles and is currently the predominant UWB generation method. However, it is not amenable to silicon IC design.

To be amenable to silicon IC design, the components used in a circuit have to conform to a foundry's component library. An SRD is a specialised component not part of the foundry's component library. Foundries do not fabricate SRDs for it is costly to specifically develop a technique and model for a particular SRD.

Furthermore, an SRD requires a large input signal power to excite it to a correct state to produce the required output. Typically, the input signal power is at a level on the order of 20 dBm which is already large. An SRD therefore does not further amplify an input signal. In fact, the SRD is basically a passive device resulting in a loss of signal power. Two examples of SRD performance can be extracted from HP Application Note 920 on “Harmonic Generation using step recovery diodes and SRD modules” to substantiate this point: “For an S-Band Damped Waveform Generator, the input signal power is 2 W (33 dBm), and the output power is 1.05 W (30 dBm)” and “For an impulse-forming network, the input power is 1 W (30 dBm) and the output is 0.532 W (27 dBm)”. In other words, the power of an SRD input signal has to be large, and the output signal cannot have larger power than the input signal.

Jeongwoo Han and Cam Nguyen also disclose that a monocyclical pulse can be generated by differentiating a Gaussian-like pulse in an RC circuit such as the circuit shown in FIG. 26, which is a simple passive RC differentiator. The frequency domain analysis of the circuit results in the equation:

$$\frac{{V}_{o}}{{V}_{i}} = \frac{R}{1 / j wC + R} = \frac{j wRC}{1 + j wRC} \approx j wRC$$

The approximation used in the equation is valid if:
jwRC<<1
Hence, the output signal is much less than 1, regardless of the values of R and C. Thus, it is not possible to have a large output signal from such an RC circuit.

In addition, the shape of the output pulse is poor. In the time domain, the input step voltage signal can be modelled by the circuit of FIG. 27. At time t0, the two switches will move from the solid line position to the dashed line position. Let t0=0 seconds. A step function is created having an infinitely small rise-time at t=t0=0 seconds. The input can be represented as

$$u ( t ) = \{ \begin{matrix}1 ⇒ t \geq 0 s \\ 0 ⇒ t \leq 0 s .\end{matrix} \\ Then at t > 0 , \\ V = IR + Q / C = R \frac{ⅆ Q}{ⅆ t} + \frac{Q}{C} .$$

Initially, at t˜0 s, a step voltage starts to accumulate charges at the left plate of capacitor, thus forcing current i down to the resistor R. However, because charge accumulation takes time, Vout,initial=u(t), since u(t) is instantaneous step:

$${V}_{initial} = IR = R \frac{ⅆ Q}{ⅆ t} = u ( t ) ⇒ \frac{ⅆ Q}{ⅆ t} = \frac{u ( t )}{R} .$$

As time passes, the capacitor charges up and
Q=CV

where V is voltage across the capacitor. At t>>0, there is no more current passing through resistor, i.e. i=0 and V_{o, final}=0 V. The initial and final state of the circuit suggests that

$$I = \frac{ⅆ Q}{ⅆ t} {ⅇ}^{- Kt} = \frac{u ( t )}{R} {ⅇ}^{- Kt}$$

$$Vo = u ( t ) {ⅇ}^{- Kt} .$$

Therefore, as can be seen from the last equation, regardless of the input step rise time, the output will have an exponential decay. This leads to poor shape symmetry of the output pulse because of the slow exponential decay at small amplitudes.

An example of an active differentiating circuit, as opposed to the above-mentioned passive RC circuit, is one which uses an Operational Amplifier (op amp) having a negative feedback circuit as illustrated in FIG. 28. “Design with Operational Amplifiers and Analog Integrated Circuits” by Sergio Franco analyses this circuit in terms of its loop gain. Performing direct analysis, it is assumed that the current output from capacitor C of the differentiating op amp circuit of FIG. 28 is approximately equal to the current into resistor R. This means:

$$C \frac{ⅆ {V}_{C}}{ⅆ t} = \frac{{V}_{n} - {V}_{o}}{R}$$

$${V}_{C} = {V}_{n} - {V}_{i}$$

$${V}_{o} ( t ) = - RC \frac{ⅆ {V}_{i} ( t )}{ⅆ t} .$$

As can be seen, the output voltage is the derivative of the input voltage.

Now, performing negative feedback analysis, the total frequency response is

$$A ≡ \frac{{V}_{o}}{{V}_{i}} =. \frac{1}{b} . \frac{1}{1 + 1 / ab} .$$

It is often the case with op amp circuits that the loop gain is sufficiently large (ab>>1) to approximate:

$$A ≅ {A}_{ideal} = \frac{1}{b} .$$

In the case of the circuit of FIG. 28:

$$\frac{1}{b} = \frac{1}{b ( j f )} = 1 + j ( \frac{f}{{f}_{o}} )$$

where fₒ=½πRC.

As shown in the above frequency domain analysis, it approximates a differentiating circuit, which is its purpose. However, a differentiating op amp does not fulfill the purpose of Applicants' invention, as will be explained in the detailed description.

FIG. 5 shows a method of UWB Signal Generation described in WO 99/53616 “Monopulse Generator,” Stevens, Roderick, Leonard and Wallace. In this method, a high frequency oscillator generates continuous sinusoid signal, A, which is fed into a window pulse generator 52 and a delay block 53. The delay block output, signal B, is a delayed version of signal A. The window pulse generator produces a windowing pulse, C, which turns a switch 54 on-and-off to pass signal B at appropriate moments. The resultant signal, D, is a windowed sinusoid pulse of one period which is approximately a monocycle. This method of UWB signal generation has a problem of LO signal being leaked to the output, corrupting the UWB signal.

FIG. 6 shows a method of UWB Signal Generation described in “Cellonics Presentation at Ultra-Wideband Seminar”, Infocomm Development Authority, Singapore, 25 Feb. 2003, Dr. Jurianto Joe. In this method, a short pulse width 61 is fed into a nonlinear circuit based on a tunnel diode 62, which causes an oscillatory response within the pulse window. This response is also a kind of UWB signal 63. This method of UWB signal generation is also not amenable to silicon IC design as a Tunnel diode is, like SRD, a very specialised component. Quoting from Electrical Engineering Training Series by Integrated Publishing (see the web-site: www.tpub.com/content/neets/book7/26a.htm), “In a Tunnel diode, the semiconductor materials used in forming a junction are doped to the extent of 1000 impurity atoms for 10 million semiconductor atoms.” However, a normal diode is lightly doped with one impurity per 10 million semiconductor atoms. Hence, a tunnel diode is a very specialised component which is expensive and not available in most foundries.

None of the above-described methods is singularly amenable being implemented in an IC design while being risk-free from LO signal leakage and providing a sufficient power swing for antenna transmission.

### SUMMARY OF THE INVENTION

This invention describes a new method of using transistors to generate and/or shape UWB pulses of pulse-width of <100-picosecond. The proposed method of UWB signal generation is fundamentally different from the prior art and has inherent advantages which overcome many limitations in the prior art.

The proposed method is able to generate a large signal output swing to generate large output power. The method also does not have the problem of LO signal leaking into the UWB signal. The method additionally provides a high pulse repetition rate and provides significant control over the generated UWB pulse (i.e. the pulse amplitude, pulse width, pulse shape and pulse repetition can be controlled). Furthermore, the method is useable to generate various types of UWB signals such as monocycles, polycycles or biphase signals. The device of this invention has small circuit size and can be designed into and implemented in an IC.

According to the invention in a first aspect, a method for generating UWB signals is proposed comprising the step of differentiating a clock signal once to obtain a UWB pulse.

According to the invention in a second aspect, a system is proposed comprising amplifying means, negative feedback means, a low-pass filtering means, a DC decoupling means, and the amplifying means providing an output of the system fed to the low-pass filtering means, the low-pass filtered output of the amplifier is negatively fedback to the input means of the amplifier, the DC decoupling means removing any DC component in the amplifier output, wherein the output from the system is an amplified differential of an input signal to the system, and whereby a UWB pulse having sufficient power for matching to a transmitting antenna is produced.

According to the invention in a third aspect, a method is proposed comprising the steps of using a substantially step changing signal as a first input, differentiating the first input to obtain a first pulse signal, mixing the first pulse signal with a second input, the second input being a data signal, to produce a second pulse signal and differentiating the second pulse signal to produce a third pulse signal wherein the third pulse signal is a UWB pulse signal.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1a shows a 1-ns pulse width Gaussian monocycle in the time domain

FIG. 1b shows a 1-ns pulse width Gaussian monocycle of FIG. 1a in the frequency domain

FIG. 1c shows the bandwidth for UWB approved for use in Indoor Systems according to the FCC.

FIG. 1d shows the bandwidth for UWB approved for use used in Outdoor Handheld Systems according to the FCC.

FIG. 1e shows the bandwidth for UWB approved for use used in GPR, wall imaging and medical imaging systems according to the FCC.

FIG. 1f shows the bandwidth for UWB approved for use used in ‘through-wall’ imaging and surveillance systems according to the FCC.

FIG. 2a illustrates the method of UBW pulse generation according to WO 02/31986.

FIG. 2b further illustrates the method of UBW pulse generation of FIG. 2a.

FIG. 3 illustrates the method of UWB pulse generation according to U.S. Pat. No. 6,026,125.

FIG. 4 illustrates the method of UWB pulse generation according to Jeong Soo Lee, Nguyen and Scullion, and the method according to Jeongwoo Han and Nguyen.

FIG. 5 illustrates the method of UBW pulse generation according to WO 99/53616.

FIG. 6 illustrates the method of UBW pulse generation disclosed in Cellonics Presentation in Ultra Wideband Seminar, Infocomm Development Authority, Singapore, 25 Feb. 2003, Dr. Jurianto Joe.

FIG. 7 illustrates the effect of an embodiment of the invention.

FIG. 8 is a graph showing the transfer function of an embodiment of the invention.

FIG. 9 is a graph showing the transfer function of FIG. 8 approximated by a first-order high-pass filter.

FIG. 10 shows a circuit low pass filtering the negative feedback.

FIG. 11 shows the equivalent of the circuit of FIG. 10 represented in frequency function blocks.

FIG. 12 shows a current-voltage (series-series) feedback topology equivalent to the block diagram of FIG. 11.

FIG. 13 is a further illustration of the current-voltage (series-series) feedback topology of FIG. 12.

FIG. 14 shows a hybrid-π small signal circuit

FIG. 15 shows the schematics of a simple test circuit of the embodiment of FIG. 12.

FIGS. 16a-f are graphs showing the time domain response of the circuit of FIG. 12.

FIGS. 17a-f are graphs showing the time domain response of the circuit of FIG. 12.

FIG. 18 shows an embodiment of the UWB signal generator circuit equivalent to that of FIG. 12.

FIG. 19a-e illustrates the differentiating function of an embodiment of the UWB generator.

FIG. 20-23 show various impulse modulation techniques using an embodiment of the UWB generator of the invention.

FIG. 24a-d show vector representations of signal constellations according to an embodiment of the invention.

FIG. 25 is a simple representation of how a UWB signal/data is transmitted, received and detected.

FIG. 26 illustrates a simple passive RC differentiator.

FIG. 27 models the generation of an input step voltage signal for input into the passive RC differentiator of FIG. 26.

FIG. 28 illustrates active differentiating circuit using an Operational Amplifier having a negative feedback circuit.

### DETAILED DESCRIPTION OF THE PREFERRED EMBODIMENT

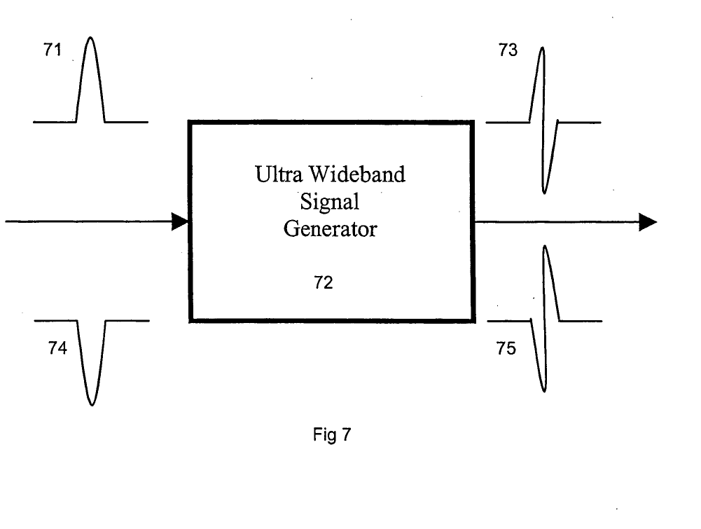

FIG. 7 illustrates the basic function of an embodiment of the UWB generator of the present invention. A positive pulse 71 (Gaussian-like) is fed into an embodiment of the UWB signal generator 72 and is converted into a monocycle pulse 73. Conversely, a negative pulse 74 is converted into a monocycle 75 which is the inverse of the monocycle pulse 73. The fundamental operation of the UWB signal generator 72 is ultra broadband differentiation and amplification of input signals. A circuit in the UWB signal generator takes in a train of broadband sub nanosecond pulses, differentiates and amplifies them to output a train of UWB signals. An output monopulse has a slightly longer time-width than that of the input pulse.

The following equation describes the differentiating function of the circuit in the time domain.

$$y ( t ) = K \frac{ⅆ x ( t )}{ⅆ t}$$

Where,

x(t) is the input signal to the block; and

y(t) is the desired output signal.

The circuit effects frequency selective amplification and suppression which is different from higher harmonic generation using component nonlinearity. Therefore, there is no limitation to circuit operation at high duty cycles.

To synthesise the above function, the equation is Fourier-transformed into the frequency domain and the transfer function as shown below is derived.

$$Y ( w ) = {\int }_{- ∞}^{∞} K \frac{ⅆ x ( t )}{ⅆ t} {ⅇ}^{- ⅈ wt} ⅆ t = ⅈ KwX ( w )$$

$$H ( w ) = \frac{Y ( w )}{X ( w )} = ⅈ Kw$$

$$\vert H ( f ) \vert = 2 π Kf$$

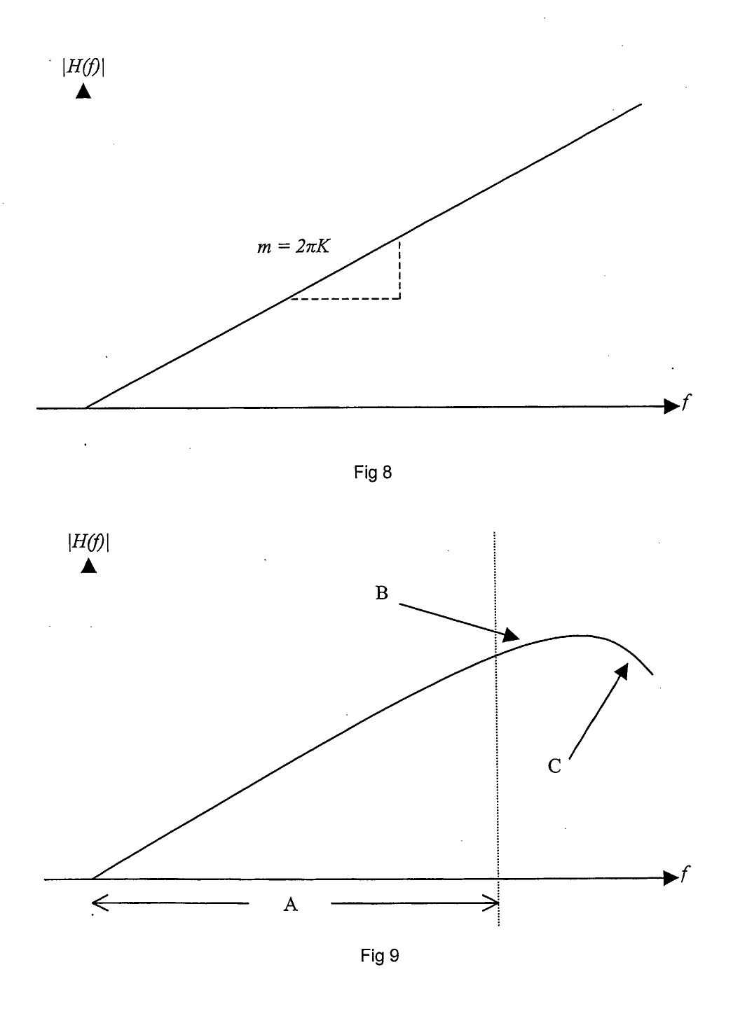

The frequency domain equation shows that if a circuit having a transfer function |H(f)|, as illustrated in FIG. 7, can be synthesised, then an input signal can be differentiated in the time domain. The transfer function |H(f)| is shown graphically in FIG. 8.

Strictly speaking, a circuit of the transfer function |H(f)| cannot be synthesised. However, one can use a first-order high-pass filter to approximate it. FIG. 9 shows an illustration of the approximated transfer function.

The present embodiment of UWB signal generator has an active first order high-pass filter with transmission zero at DC, ultra-broad transition band and passband at frequencies near the transit frequencies of the transistors used in the circuit, i.e. the transistors work within their saturation limit. Having a transmission zero at DC and an ultra-broad transition band enables the UWB signal generator to generate very short pulses (to the order of subnanosecond) while shorting out any steady-state DC component in the input signal.

The filter used is an active one as amplification is required for the overall filter response to achieve sufficient signal power output.

The high pass filter transition band is limited by the overall frequency response of the active device (or devices) that implements it. Hence, it is essential to choose an active device with very high transit frequency. As illustrated in FIG. 9, ‘A’ is the transition band, ‘B’ shows the intentional tapering of the transfer function by a capacitor of the analog filter while ‘C’ shows the gradual deterioration of transistor performance at high frequencies.

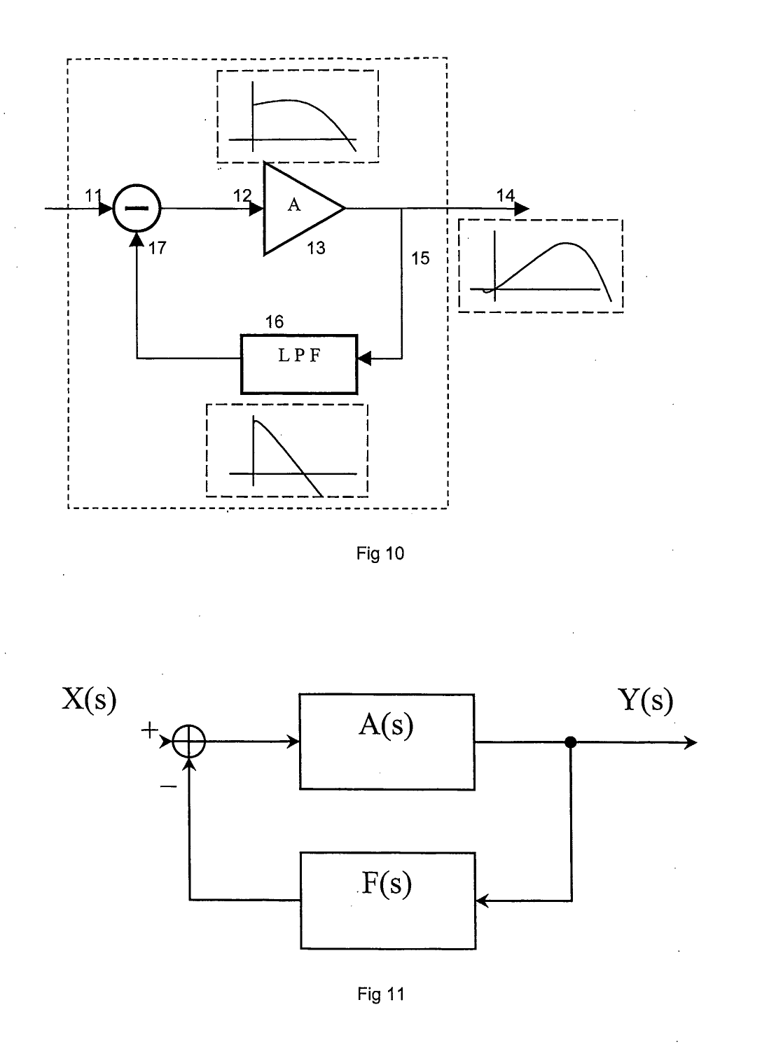

The above-mentioned frequency domain function is implemented with a negative feedback path on a normal amplifying circuit as shown in FIG. 10. The output signal 14 of an amplifier 13 passes (at 15) through a low pass filter 16 and is negatively fed back 17 to the input 11 of the amplifier 13. In this way, the lower frequency component of the input signal 11 is eliminated before the remaining signal 12 comprising the higher frequencies is received by the amplifier 13. When the output signal 15 is negatively 17 fed back to the input 11 the transfer function of the whole block of components is effectively altered, forming the differentiating function.

As described above, the transistor amplifier 13 has a band limited transfer function. The circuit block can only differentiate signals up to a frequency below that of the transistors' transit frequencies. Suitable transistors are chosen having suitable output signal power, amplification and operation frequency.

FIG. 10 can also be represented in frequency dependent function blocks as shown in FIG. 11, where

$$A ( s ) = \frac{{A}_{0}}{1 + \frac{s}{{w}_{t}}}$$

$$F ( s ) = \frac{{β}_{0}}{1 + \frac{s}{{w}_{f}}}$$

$$H ( s ) = \frac{Y ( s )}{X ( s )} = \frac{A ( s )}{1 + F ( s ) A ( s )}$$

$$H ( s ) = \frac{{A}_{0} ( 1 + \frac{s}{{w}_{f}} )}{1 + {A}_{0} {β}_{0} + s ( \frac{1}{{w}_{t}} + \frac{1}{{w}_{f}} ) + {s}^{2} ( \frac{1}{{w}_{t} {w}_{f}} )} \\$$

Under the conditions

$${A}_{0} {β}_{0} \text{≻≻} 1$$

$$1 \text{≺≺} \frac{s}{{w}_{f}} \text{≺} \text{≺} {A}_{0} {β}_{0}$$

$${w}_{t} \sim {w}_{f}$$

the transfer function of the feedback loop of FIG. 11 can be approximated as

$$H ( s ) ≅ ( \frac{1}{{β}_{0} {w}_{f}} ) s \qquad ( 1 )$$

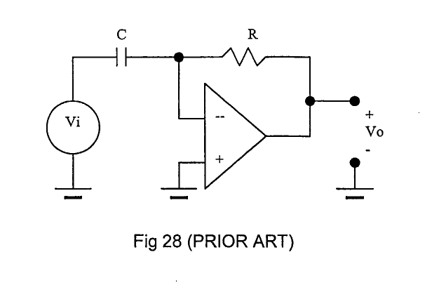

The circuit shown in FIG. 10 looks similar to the differentiating circuit using the op amp of FIG. 28 described in the Background section above. However, it should be noted that the core component of the present invention is not an op amp, but rather, in a preferred embodiment is a BJT transistor. This difference is especially marked considering that the op amp is an analog circuit component that operates in MHz region. The present invention, on the contrary, generates subnanosecond pulses of a power sufficient for the RF transmitter and operates by a totally different set of parameters.

Furthermore, the component orientation of the present invention is different from that of the op amp differentiating circuit. In the op amp differentiator, the input signal voltage is converted into its own differentiated current signal. As the input, current into the op amp negative terminal is negligible, and the current signal passes through the resistor R, which converts the current signal into an output voltage signal of opposite polarity. Therefore, the differentiating op amp has an operating principle which is different from that of the present invention, being more similar instead to a passive RC differentiation network.

Additionally, the op amp differentiation circuit is used to differentiate slow analog signals, and it is not meant for use as a subnanosecond pulse forming network.

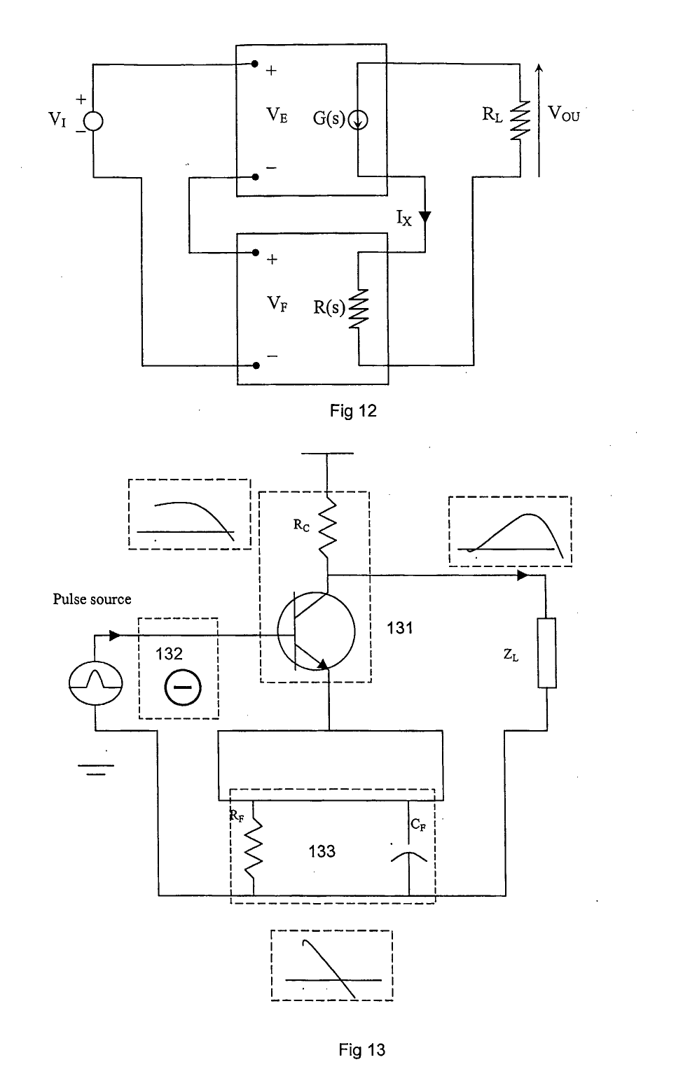

A current-voltage (series-series) feedback topology as shown in FIG. 12 shows an example of a realisation of the block diagram of FIG. 11, where

$$\begin{matrix}G ( s ) = \frac{{I}_{X}}{{V}_{E}} = \frac{{G}_{0}}{1 + \frac{s}{{w}_{t}}} & ( 2 ) \\ R ( s ) = \frac{{V}_{F}}{{I}_{X}} = \frac{{R}_{0}}{1 + \frac{s}{{w}_{f}}} & ( 3 )\end{matrix}$$

It can be shown that

$$\frac{{V}_{OUT}}{{V}_{IN}} = \frac{- G ( s ) {R}_{L}}{1 + G ( s ) R ( s )} \qquad ( 4 )$$

Substituting (2) and (3) in the block transfer function (4) gives

$$H ( s ) = \frac{{V}_{OUT}}{{V}_{IN}} = \frac{- {G}_{0} ( 1 + \frac{s}{{w}_{f}} ) {R}_{L}}{1 + {G}_{0} {R}_{0} + s ( \frac{1}{{w}_{t}} + \frac{1}{{w}_{f}} ) + {s}^{2} ( \frac{1}{{w}_{t} {w}_{f}} )}$$

Under the conditions

$${G}_{0} {R}_{0} \text{≻≻} 1$$

$$1 \text{≺} \text{≺} \frac{s}{{w}_{f}} \text{≺≺} {G}_{0} {R}_{0}$$

$${w}_{t} \sim {w}_{f}$$

the frequency domain transfer function of the current-voltage (series-series) feedback topology of FIG. 12 can be approximated as

$$H ( s ) ≅ - ( \frac{{R}_{L}}{{w}_{f} {R}_{0}} ) s \qquad ( 5 )$$

Equation (5) is equivalent expression of equation (1).

Other feedback topologies, for example, voltage-voltage, voltage-current and current-current can be designed using similar blocks and the same concept.

A circuit of the above feedback topology can be implemented in an Integrated Circuit (IC).

An embodiment of a circuit implementing the current-voltage (series-series) feedback topology of FIG. 12 is shown in FIG. 13. The layout of FIG. 13 is a common-emitter configuration of bipolar junction transistor 131 which implements an amplifier and an emitter feedback network which provides the negative feedback 132. The feedback network comprises a first order low pass filter 133. The dashed boxes highlight the functional blocks and the components within the blocks show the manner in which the feedback is subtracted. In the figure, the low pass filter 133 corresponds to the low pass filter 16 of FIG. 10. Similarly, the BJT configuration 131 corresponds to the amplifier 13 in FIG. 10 and the negative feedback 132 corresponds to the negative feedback loop 17 in FIG. 10.

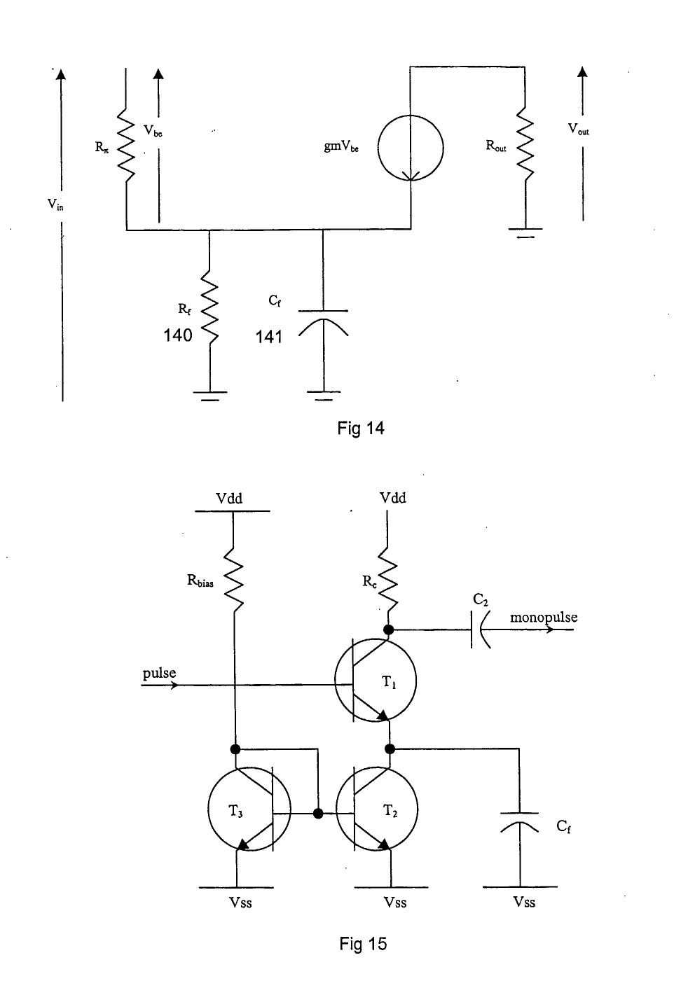

FIG. 14 shows a hybrid-π small signal circuit equivalent to the above-mentioned bipolar junction transistor 131. The feedback network is connected at the emitter side. Rₒᵤₜ is a parallel connection of the collector resistor and output impedance. Vᵢₙ is the input voltage pulse signal to the transistor R_{π}. V_{be} and gₘ are transistor parameters that are bias dependent.

Solving Kirchoffs current and voltage laws at certain nodes and loops, one can obtain the following transfer function of the circuit at small signal operation:

$$T ( w ) = \frac{{V}_{out} ( w )}{{V}_{i n} ( w )} = - \frac{{g}_{m} {R}_{out} ( 1 + {jwR}_{f} {C}_{f} )}{1 + {g}_{m} {R}_{f} + \frac{{R}_{f}}{{R}_{π}} + {jwR}_{f} {C}_{f}}$$

Instead of using a large value R_{f} resistor at the emitter side, a current mirror configuration is used, so as to provide a constant supply current at DC, and to provide large impedance at AC/RF conditions.

Given

$$1 + {g}_{m} {R}_{f} + \frac{{R}_{f}}{{R}_{π}} \text{≻≻} {jwR}_{f} {C}_{f}$$

$${wR}_{f} {C}_{f} \text{≻≻} 1$$

$$T ( w ) ≅ - jw ( \frac{{g}_{m} {R}_{out} {R}_{f} {C}_{f}}{1 + {g}_{m} {R}_{f} + \frac{{R}_{f}}{{R}_{π}}} ) = - jwK$$

a differentiating transfer function can be derived.

The above discussed circuit has been simulated in Cadence using IBM BiCMOS6HP process components.

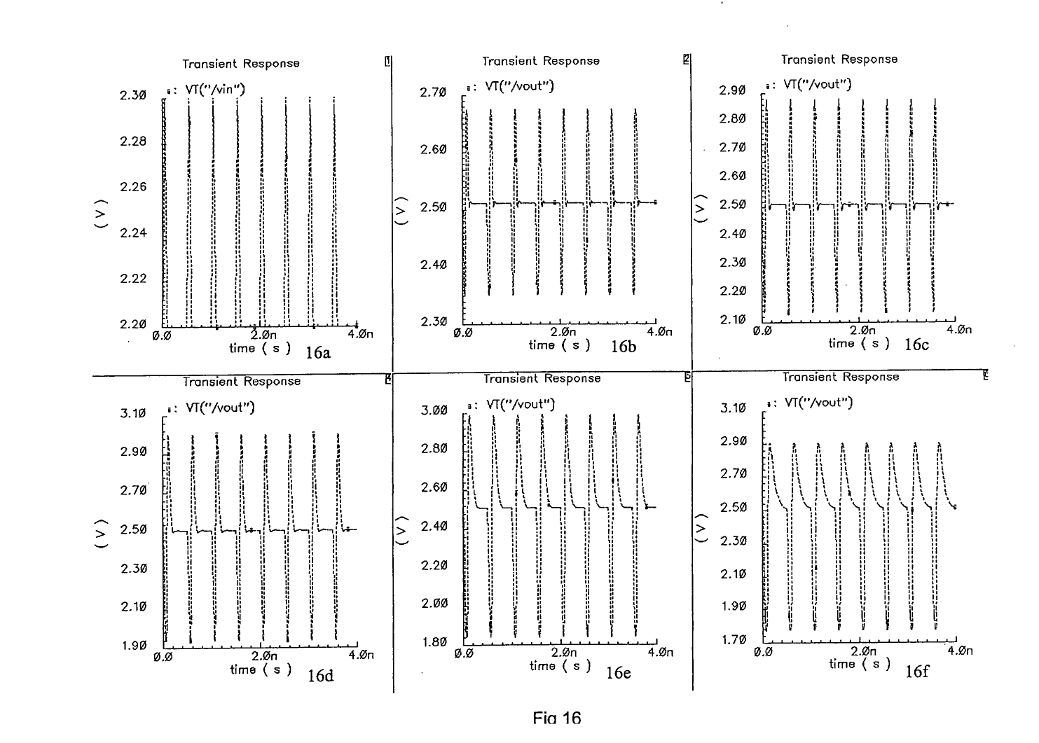

FIG. 15 shows the schematics of a circuit for the embodiment. In this figure, T₁ is the amplifying transistor that provides the signal gain and delineates the input and output of the circuit. T₂ provides a constant DC biasing current and a large feedback resistance at AC operation. T₃ completes the current mirror configuration with T₂. R_{bias} sets a constant voltage for the biasing current. C_{f} is the feedback capacitor 141 of FIG. 14. T₂, if biased properly, operates at saturation region, and provides a large Rf value for the feedback resistor 140 of FIG. 14. C₂ is a DC decoupling capacitor. The input pulse goes into the base of transistor T₁. The output monopulse results from the collector voltage swing of transistor T₁. This test circuit was simulated for a range of capacitor C_{f} values to illustrate the frequency and time domain response of the embodiment. FIGS. 16a-f show the time domain response of the simulations.

FIG. 16a shows an input pulse signal of 0.1V peak, biased at 2.2V which was fed into the circuit of FIG. 15. FIGS. 16b-f shows the time domain response of the circuit for a range of different capacitor values. The output monopulse shape and time duration can be varied with different values of capacitance. It can be seen that a very high duty, symmetrical profile monopulse with minimal ringing can be produced. The capacitance values are 0.1 pF, 0.2 pF, 0.6 pF, 1 pF and 2 pF corresponding to FIGS. 16b,c,d,e, and f.

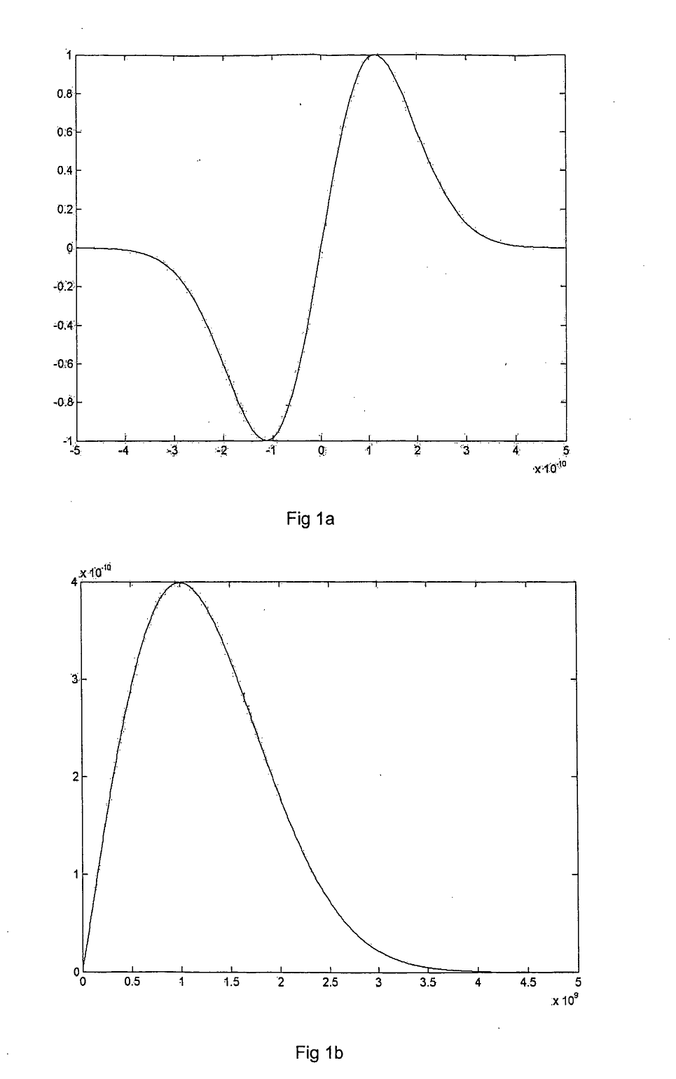

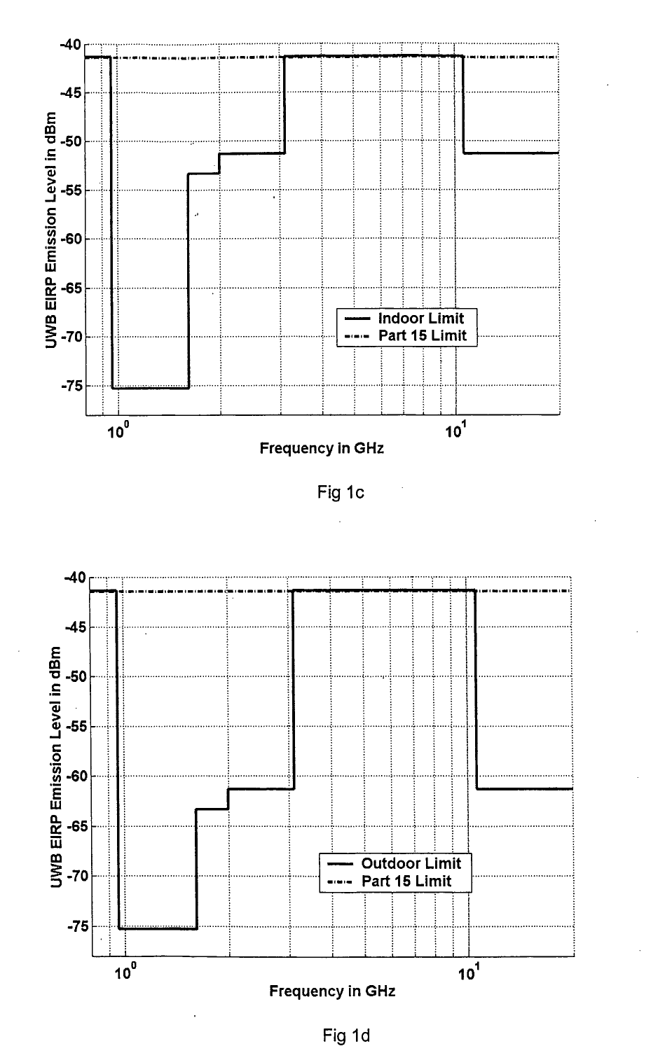

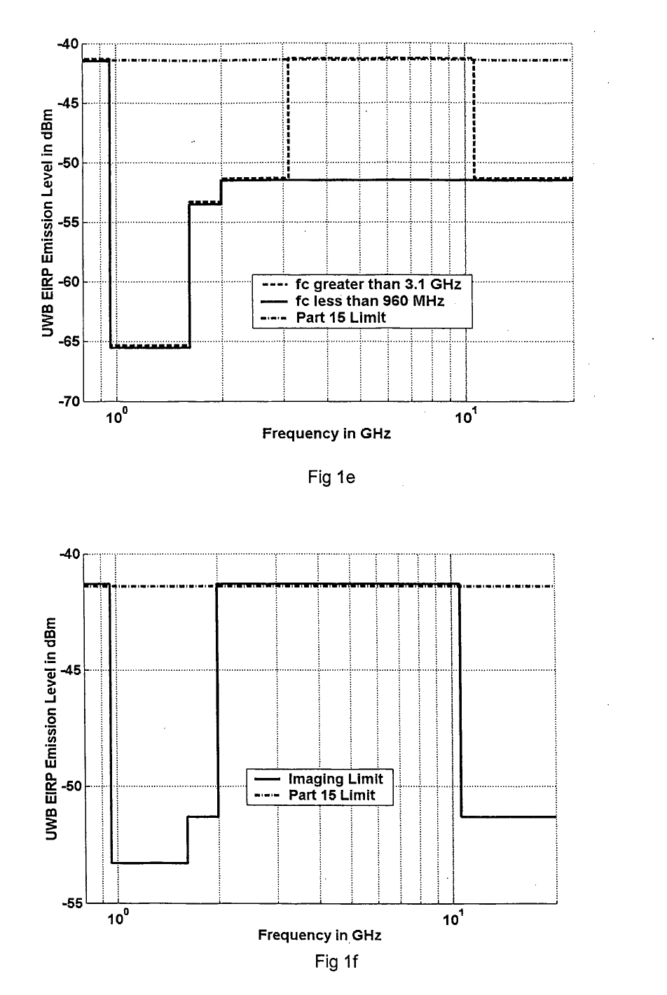

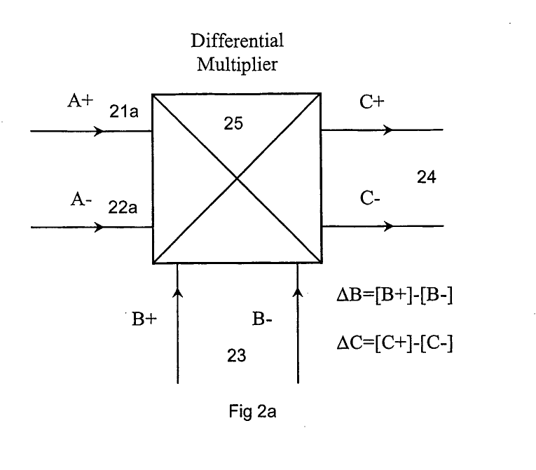

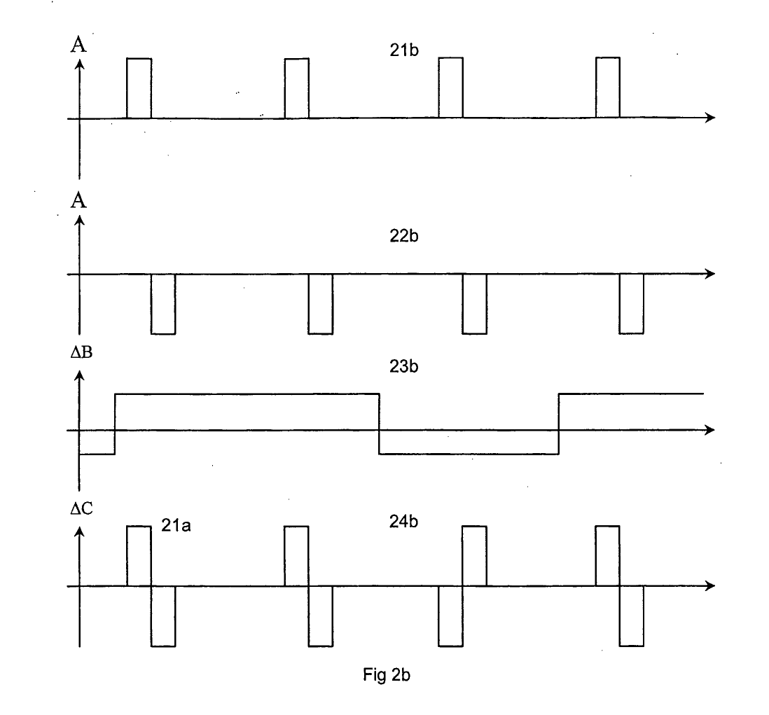

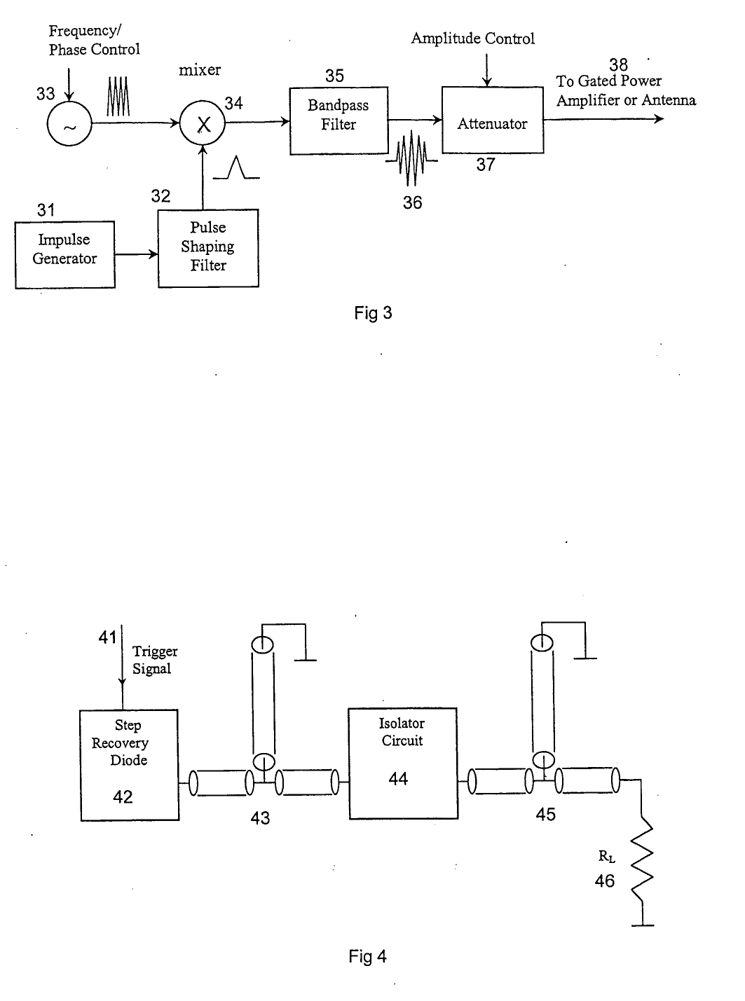

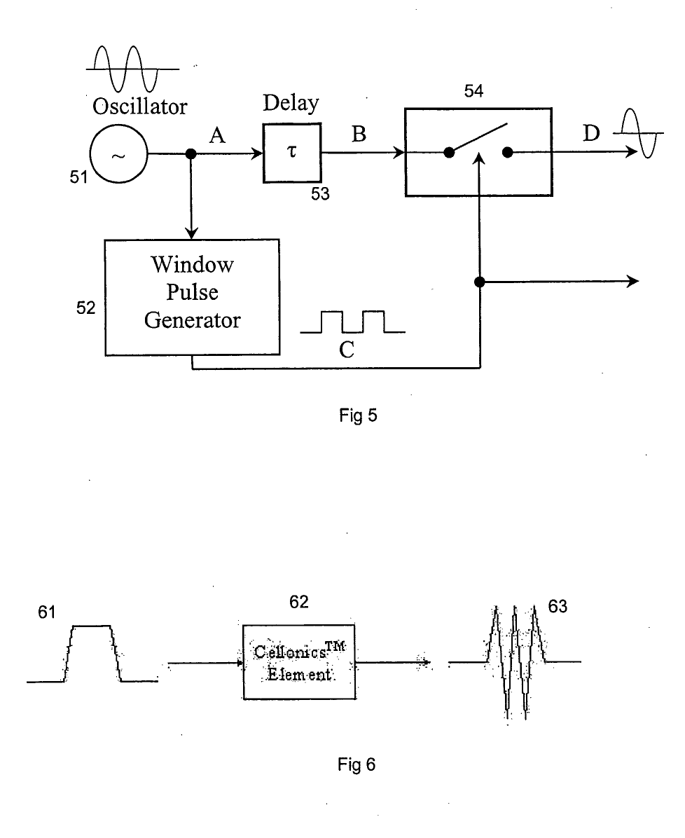

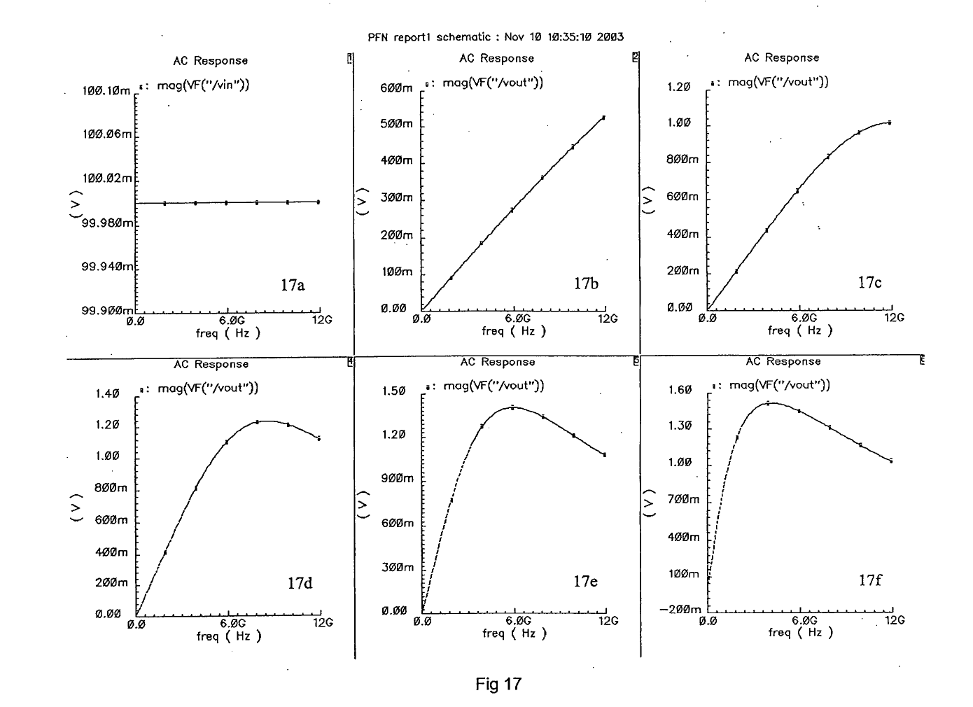

FIGS. 17a-f show the frequency domain response of the test circuit. FIG. 1 7a shows the input sweep sinusoidal voltage value at 0.1 V for frequencies from 0 Hz to 12 GHz. FIGS. 17b-f shows the frequency domain response of the test circuit for a range of capacitor values. The capacitance values are 0.1 pF, 0.2 pF, 0.6 pF, 1 pF and 2 pF corresponding to FIGS. 17b,c,d,e, and f. As can be seen, the simulated results correspond with the results from the mathematical derivation discussed above: increasing the capacitance shrinks the passband of the high pass filter, differentiating only a certain range of input signal frequencies while amplifying the other frequencies. Hence, low capacitance is preferable as it ensures operation of the differentiator circuit over a large range of frequencies. This corresponds to the discussion referring to FIG. 9 on the compromise between operation frequency and output signal amplification of the UWB signal generator. The analysis and simulations therefore show that the circuit illustrated in FIG. 13 is capable of differentiating a broadband input signal, subjected to the known frequency performance of the transistor 131 and the time constant of Rf and Cf 133, 140, 141.

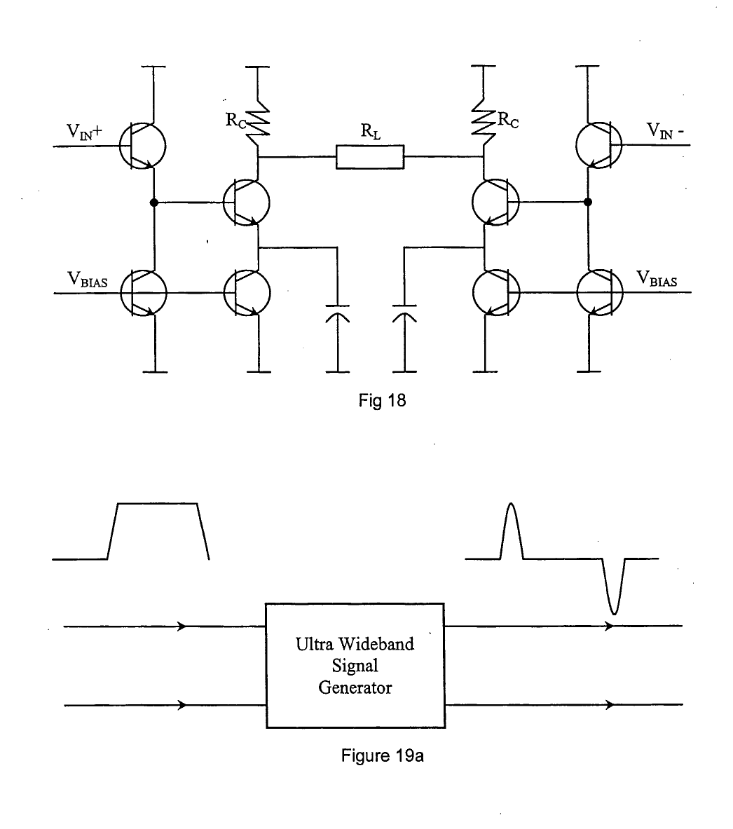

An embodiment of the differentiating circuit of the UWB signal generator as shown in FIG. 18 has been fabricated in a BiCMOS IC, and it has been shown that a 100-picosecond pulse output is feasible.

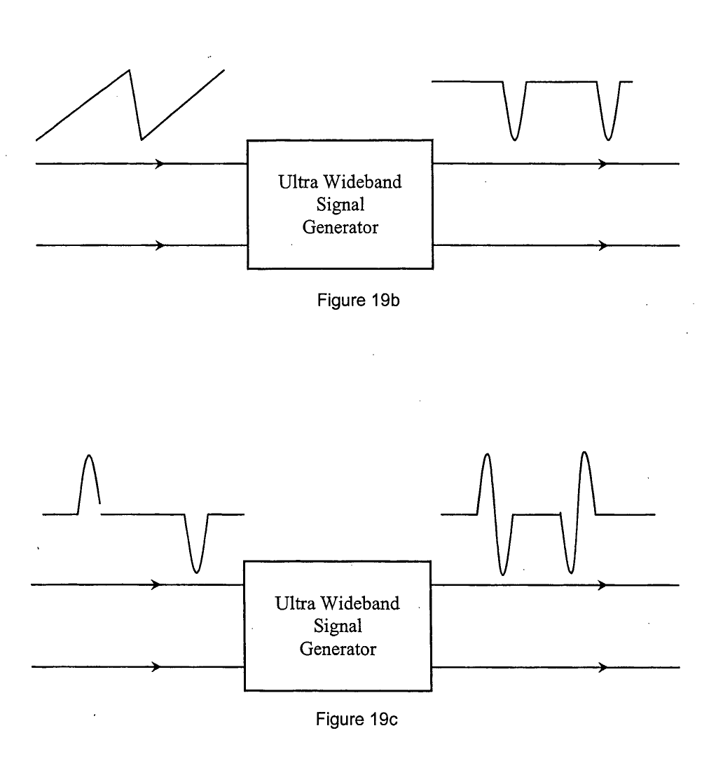

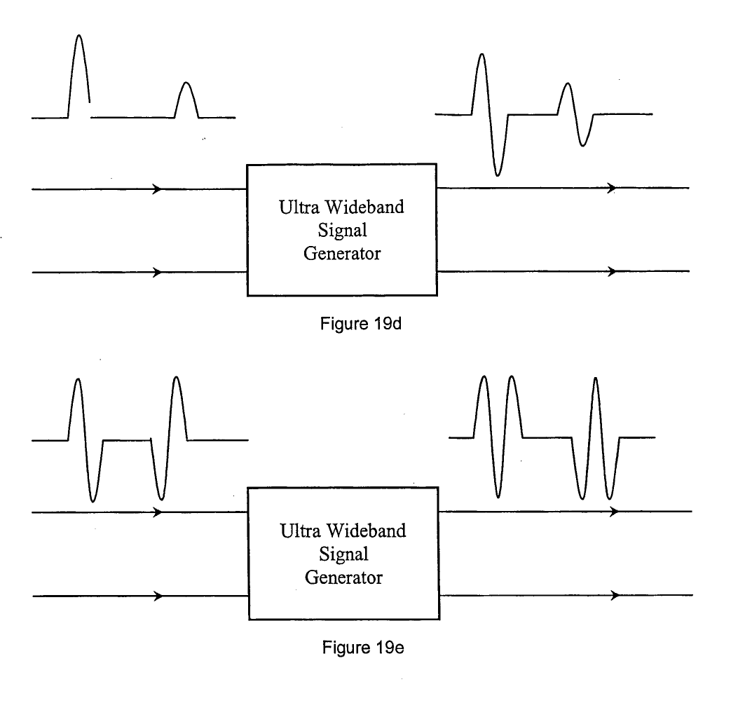

FIG. 19a-e shows a few examples of the use of the circuit of FIG. 18. The circuit of FIG. 18 can be substituted for the UWB signal generator block in FIG. 19a-e. As can be seen in the figures, generation of information-transmitting UWB signals is a matter of cascading the proposed circuit with other components and feeding in the right kind of clock signal.

FIG. 19a illustrates the differentiation of a clock signal by a circuit of the embodiment. FIG. 19b illustrates the differentiation of a saw-tooth signal by a circuit of the embodiment. FIG. 19c illustrates the differentiation of Gaussian (or Gaussian-like pulses) having positive and negative amplitudes by a circuit of the embodiment. FIG. 19d illustrates the differentiation of a series of Gaussian or Gaussian-like pulses having different amplitudes by a circuit of the embodiment. FIG. 19e illustrates the differentiation of a monocycle and a reverse monocycle by a circuit of the embodiment. The above illustrations in FIG. 19a-e are non-exhaustive and have further variations as would be known to one skilled in the art upon reading this disclosure to produce other UWB signal forms.

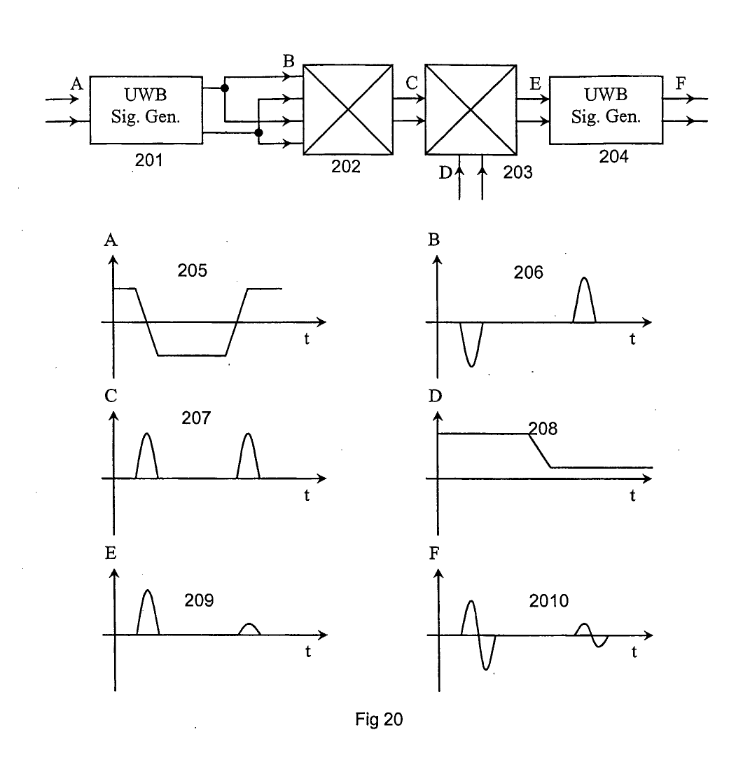

FIGS. 20-23 show various impulse forming implementation schemes (Impulse Formers) that generate UWB signals using the present embodiment of UWB signal generator. A clock signal and a data signal are used as inputs to the Impulse Former, which outputs signals to a transmission antenna. The UWB signal generator directly affects the efficiency of the Impulse Former. It should be noted that amplitude modulation of the monocycle is a form of amplitude waveform coding; pulse position modulation of the monocycle is a form of orthogonal waveform coding; biphase modulation of the monocycle is a form of antipodal waveform coding; while 4-ary signalling modulation of monocycle is a simple combination of orthogonal and antipodal waveform coding, resulting in optimal usage of channel bandwidth.

FIG. 20 illustrates how a data signal may be converted to UWB pulses for transmission by generating an amplitude modulated monocycle train. A differential clock signal ‘A’ 205 is fed into a UWB signal generator 201 of the present embodiment to be differentiated. The resultant output ‘B’ is a train of Gaussian pulses with positive and negative amplitudes 206 due to the gradients of the clock signal 205. Signal B is then fed into a differential mixer 202 to be squared to become solely-positive signal ‘C’ 207, thus transforming the negative pulses into positive ones 207. Signal ‘C’ 207 is then modulated with data signal ‘D’ 208 at modulator/mixer 203, and the resultant amplitude modulated waveform ‘E’ 209 is produced. The output ‘E’ 209 is fed into another differentiating UWB signal generator 204 of the embodiment and an amplitude modulated UWB monocycle train ‘F’ 2010 is produced for transmission.

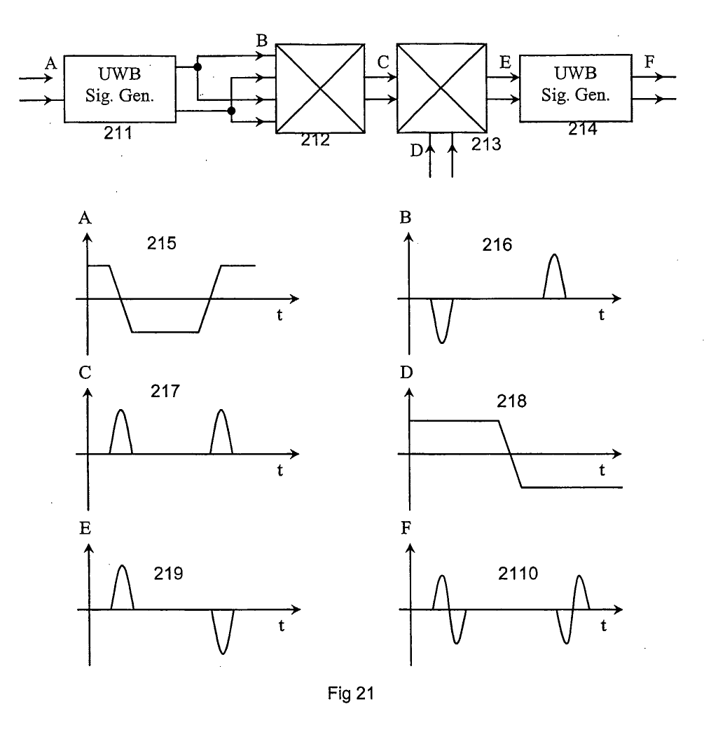

FIG. 21 provides an example of generating a biphase monocycle train 2110. A differential clock signal ‘A’ 215 is fed into a UWB signal generator of the present embodiment 211. The output ‘B’ 216 is then fed into a differential mixer 212 to be squared to become signal ‘C’ 217. ‘C’ 217 is then modulated with data signal ‘D’ 218 at a modulator 213, and the resultant waveform ‘E’ 219 is produced. (Note that ‘D’ 218 has positive and negative amplitudes, unlike signal ‘D’ 208 of FIG. 20). ‘E’ 219 is fed into another UWB signal generator of the present embodiment 214 for another round of differentiation and a biphase UWB monocycle train 2110 is produced.

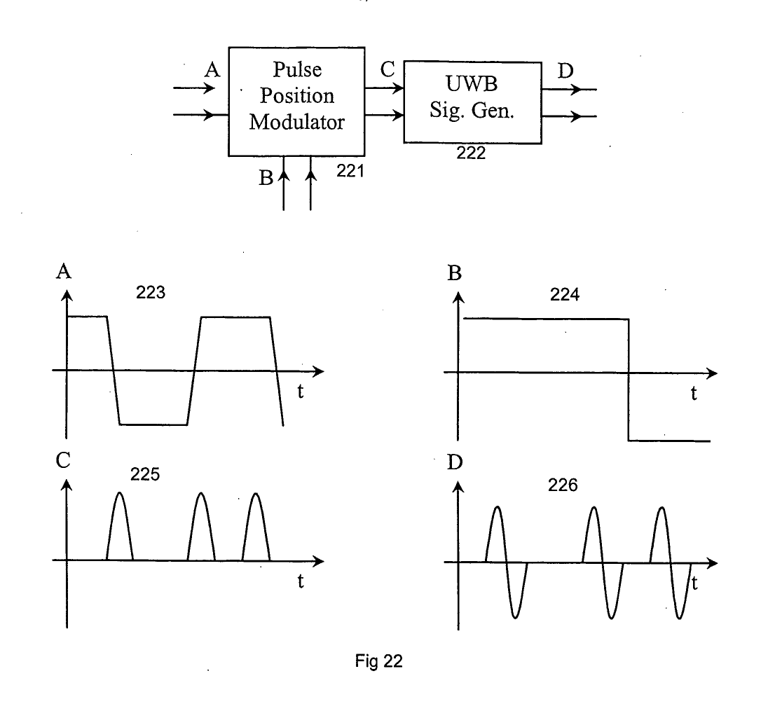

In the example of FIG. 22, the generation of a pulse position modulated monocycle train 226 is illustrated. A clock signal ‘A’ 223 and data signal ‘B’ 224 are fed into a pulse position modulator 221. The output, pulse-position-modulated pulses ‘C’ 225, is fed into a UWB signal generator of the present embodiment 222 to generate ‘D’, UWB monocycles 226. The methods of pulse-position-modulation is well known in the art and requires not further exposition.

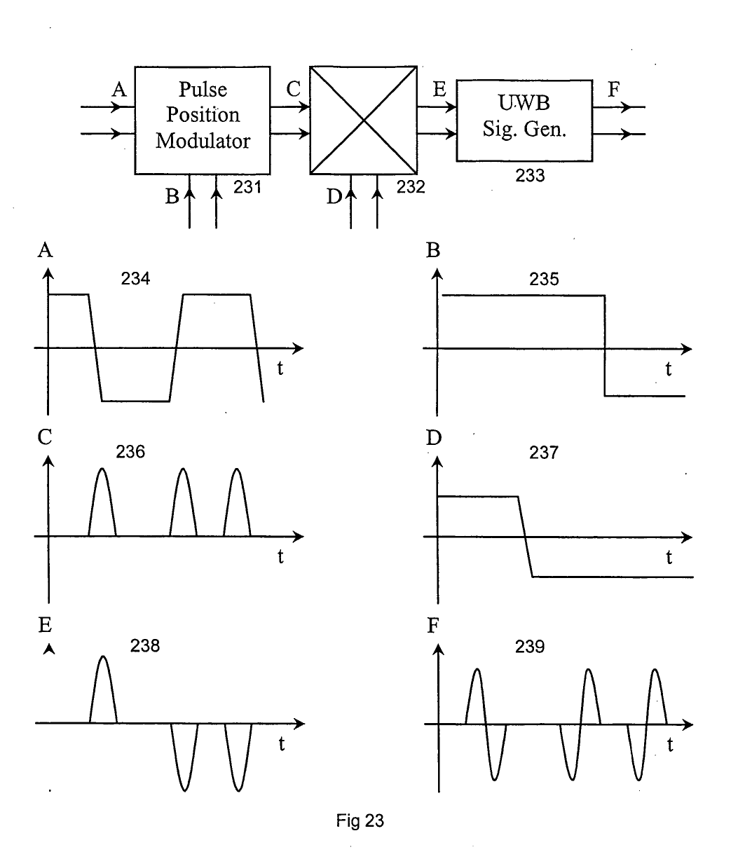

In the example of FIG. 23, the generation of a 4-ary signalling modulated monocycle train 239 is illustrated. Clock signal ‘A’ 234 and data signal ‘B’ 235 are fed into a pulse position modulator 231. Pulse position modulated pulses ‘C’ 236 are then modulated with a second data signal D 237 at another modulator 232 to output a biphase, time delayed pulse train ‘E’ 238. ‘E’ is then fed into a the UWB signal generator of the present embodiment 233 to generate 4-ary UWB monocyclical signals 239.

Further to the examples given, the input signal into the UWB generator of this embodiment may be a clock signal, a square wave signal, a saw-tooth signal, a pulse, a Gaussian-like or Gaussian pulse, a monocyclical pulse, a polycyclical, a sinusoidal signal and so on.

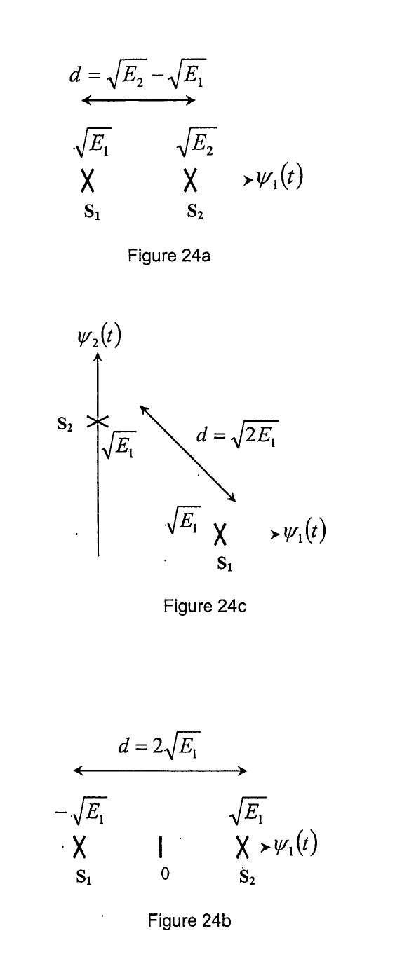

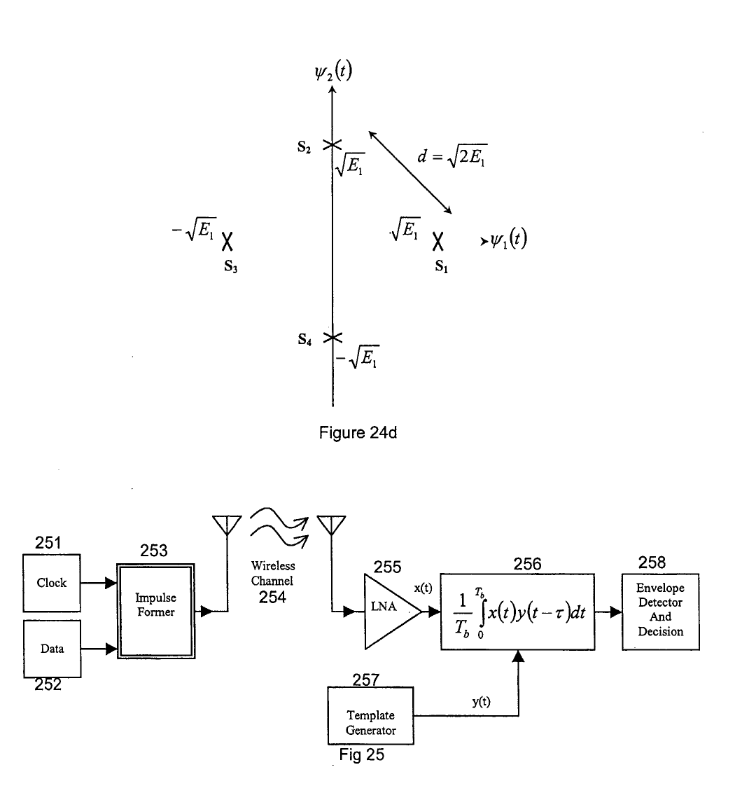

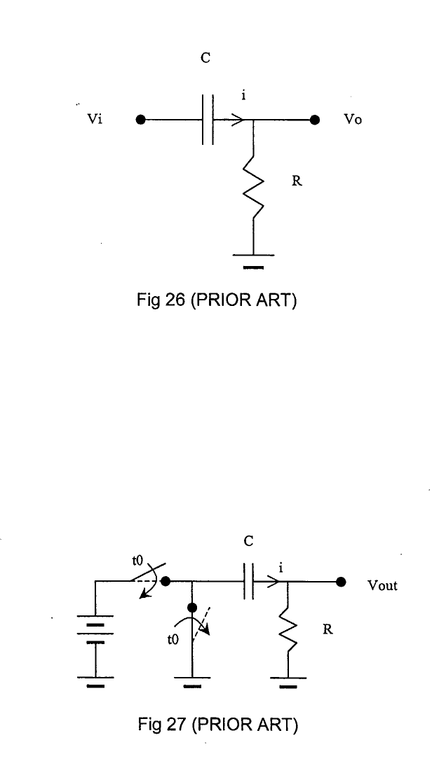

Vector representations of the above-mentioned signal constellations are shown in FIGS. 24a-d respectively. FIG. 24a corresponds to a pulse amplitude modulation (PAM) scheme for wireless communication. FIG. 24c corresponds to an orthogonal signalling modulation scheme. FIG. 24b corresponds to BiPhase Signal Keying (BPSK) modulation scheme. FIG. 24d corresponds to a Quadrature Phase Signal Keying (QPSK) modulation scheme. These are wireless communication signal modulation schemes representing the binary ‘1’s and ‘0’s in terms of different pulse shapes provided by the present invention so that the receiver is able to distinguish the ‘1’s and ‘0’s when it receives such signals.

In the above examples, a clock signal is differentiated once with the UWB generator of the present embodiment to obtain a pulse. The pulse is a “Gaussian like” spike and may not exactly be a Gaussian pulse. On differentiating a second time, a monocycle is obtained. Alternative embodiments of the invention may be a succession of two consecutively arranged UWB generators for differentiating a clock signal twice before modulation with data signal. Alternatively, a circuit implementing a second order differentiation function may be used instead. However, differentiating the clock signal twice before modulating the UWB signal output with data is more difficult, as the resultant monocycle has very a high frequency spectral content, and is thus easily distorted.

Furthermore, in an integrated circuit, there are tracks bearing the power line, ground line, ground plane, and many other important signal lines that should not be interfered with by the high power, monocycle pulse. The extent of leakage of a UWB signal generated in one line to another line depends on the signal power and frequency, as well as the dimensions and positions of the lines. As a UWB monocycle has is broadband, has high power and high frequency, it is very easily leaked to other lines in an IC causing interference to those lines and causing itself to loose power and suffer distortion. In addition, differentiating the clock signal twice before modulating the UWB signal output with data results in a monocycle having very a high frequency spectral content increasing leakage to the other tracks. Therefore, it is preferable to produce powerful monocycles only at the last stage of the circuit where the signal is fed directly to an antenna for transmission.

Therefore, preferably the clock signal is differentiated once and modulated with data before subjecting the resultant signal to another step of differentiation. Furthermore, the second stage differentiator provides an added advantage of producing a very large output signal (IC process dependent) and hence producing monocycles at higher power compared to passive differentiators. The large power required to feed the signal to an antenna is thus produced without the need for a additional amplifier.

FIG. 25 shows a very simple representation on how a UWB signal/data is transmitted, received and detected. Clock signal 251 is used to generate the suitable impulses for modulating data 252. The clock signal and the data signal are both fed into an Impulse Former (e.g. the schemes shown in FIG. 20-23), generating UWB signals according to the methods as described. The UWB signals are then transmitted to receiving antennas. As the signals may undergo fading and distortion, and accumulate noise during transmission 254, the signal is fed into a Low Noise Amplifier (LNA) 255 and a cross-correlation detector 256 (Correlation methods are well known in the art, for example, matched filtering, partially matched filtering etc). The cross correlation detector 256 takes in 2 signals—the received signal x(t) amplified through LNA 255, and a template signal y(t) from the template generator 257. The template signal y(t) is generated based on the chip sequence by which the transmitted signal was generated, as disclosed in FIG. 20-23. The chip sequence is usually communicated between the specific transmitter and receiver in a prior period before the real data is transmitted, during the period known generally as the ‘preamble’.

Where portions of the received UWB signals and the correlation template synchronise and the cross-correlation detector gives a maximum output showing the signal correlation, the envelope detector will sample the correlator output at suitable intervals for the data and decide at which points in graphs 24a-24d the received signal belongs and thereby subsequently reconstructs the data.

Hence, the cross-correlator output to the Envelope Detector and Decision module 258 is the data meant to be received via the UWB transmission. If there is an error due to any difference between the transmitted data and the received data, a decoding module (after 258, not shown) is able to detect the errors to a certain extent.

It should be noted that the embodiments and the examples given so far of the IC implement-able UWB generating circuit, the test circuit, the transfer function producing a monopulse and the schematics of different arrangements and the input signal to produce UWB data pulses are not exhaustive. A man skilled in the art on reading this disclosure will be taught the wide possibility of alternative circuit equivalent to those described in this disclosure, and the many other possible schemes using the UWB signal generator to produce different varieties of UWB pulses (e.g. other than just monocycles).

1. A method for generating a UWB signal comprising the step of differentiating a clock signal once to obtain the UWB signal wherein the step of differentiating the clock signal comprises feeding the clock signal to an input of an amplifier and negatively feeding back an output of the amplifier, through a low pass filter, to the amplifier input.

2. A method according to claim 1 further comprising the step of differentiating the UWB signal at least once to generate a monocyclical or a polycyclical UWB signal.

3. A method according to claim 1 further comprising the step of modulating a data signal with the UWB signal to obtain a modulated UWB signal.

4. A method according to claim 3 further comprising the step of differentiating the modulated UWB signal at least once to generate a monocyclical or a polycyclical UWB signal.

5. The method of claim 3 wherein the modulated UWB signal is amplitude-modulated.

6. The method of claim 3 wherein the modulated UWB signal is pulse-position-modulated.

7. A method for generating a UWB signal in a system comprising:
an amplifier having an input and an output;
negative feedback means;
a low-pass filtering means; and
a DC decoupling means
wherein the method comprises:
providing an output of the system to the low-pass filtering means to produce a low-pass filtered output;
feeding back, by the negative feedback means, the amplifier low-pass filtered output to the input of the amplifier;
applying the DC decoupling means to remove DC components from the amplifier output; wherein
the output of the system is an amplified differential of an input signal to the system; and
whereby a UWB pulse is produced for transmission.

8. A method according to claim 7 wherein the amplifier means comprises a biased transistor.

9. A method as claimed in claim 7 wherein the input signal is a clock signal.

10. A method as claimed in claim 7 wherein the input signal is a saw tooth signal.

11. A method as claimed in claim 7 wherein the input signal is a pulse signal.

12. A method as claimed in claim 7 wherein the system is implemented in an Integrated Circuit.

13. A method as claimed in claim 7 wherein the system comprises current-voltage topology.

14. A method as claimed in claim 7 wherein the system comprises voltage-voltage topology.

15. A method as claimed in claim 7 wherein the system comprises voltage-current topology.

16. A method as claimed in claim 7 wherein the system comprises current-current topology.

17. A system comprising:
an amplifier having an input and an output;
negative feedback means;
a low-pass filtering means;
DC decoupling means;
the amplifier providing an output of the system to the low-pass filtering means to produce a low-pass filtered output;
the negative feedback means feeding back the low-pass filtered output of the amplifier is negatively fed back to the input means of the amplifier;
the DC decoupling means removing DC components from the amplifier output; wherein
the output of the system is an amplified differential of an input signal to the system; and whereby
a UWB pulse is produced for transmission.

18. A system as claimed in claim 17 wherein the amplifier means comprises of a biased transistor.

19. A system as claimed in claim 17 wherein the input signal is a clock signal.

20. A system as claimed in claim 17 wherein the input signal is a saw tooth signal.

21. A system as claimed in claim 17 wherein the input signal is a pulse signal.

22. A system as claimed in claim 17 wherein the system is implemented in an Integrated Circuit.

23. A system as claimed in claim 17 wherein the system comprises current-voltage topology.

24. A system as claimed in claim 17 wherein the system comprises voltage-voltage topology.

25. A system as claimed in claim 17 wherein the system comprises voltage-current topology.

26. A system as claimed in claim 17 wherein the system comprises current-current topology.
